(19) United States
(12) Patent Application Publication
(10) Pub. No.: US 2011/0195321 A1
(43) Pub. Date: Aug. 11, 2011

(54) RECHARGEABLE METAL-AIR BATTERY

(75) Inventors: Shin TAKAHASHI, Mito (JP); Kazuhiro YOSHIDA, Hitachi (JP); Kazushige KOHNO, Hitachi (JP)

(73) Assignee: Hitachi, Ltd.

(21) Appl. No.: 13/020,237

(22) Filed: Feb. 3, 2011

(30) Foreign Application Priority Data
Feb. 5, 2010 (JP) 2010-023697

(51) Int. Cl. H01M 12/06

(52) U.S. Cl. 429/403

(57) ABSTRACT

The present invention is intended to suppress the increase of contact resistance due to dimensional changes at the time of charge and discharge in a rechargeable metal-air battery, thereby improving battery performance and service life. The rechargeable metal-air battery of the present invention includes a negative electrode for storing and releasing metal ions; a positive electrode using oxygen as an active material; and an electrolyte membrane placed between the negative electrode and the positive electrode, and is characterized in that a flexible dimension-absorbing member is disposed on the negative electrode side, wherein the dimension-absorbing member is an elastic body formed of a substance which changes reversibly.

### BACKGROUND OF THE INVENTION

1. Field of the Invention

The present invention relates to a metal-air battery using oxygen as a cathode active material, and more particularly, to a rechargeable metal-air battery capable of charge and discharge.

2. Background Art

For reasons of increasing awareness of environmental protection and energy saving in recent years, there is fierce competition in the automotive industry to develop a hybrid electric vehicle (HEV) which concomitantly uses motors driven by gasoline and electricity and an electric vehicle (EV) driven by an electric motor alone, as substitute for conventional gasoline-fueled automobiles.

The characteristics of a storage battery serving as a source of electrical energy supply have a great influence on the performance of these electric vehicles. Consequently, battery manufacturers affiliated with respective electric vehicle manufacturers are engaged in fierce competition to develop a rechargeable lithium-ion battery.

The rechargeable lithium-ion battery, for its lightweight and high output, is the most promising for use as a storage battery in electric vehicles.

However, the theoretical upper limit of the battery's weight energy density is considered to be 400 Wh/kg or so. An actually available weight energy density is approximately 100 Wh/kg.

A weight energy density of approximately 500 Wh/kg is said to be necessary for the full-blown spread of electric vehicles. Currently, there is a demand for development of an innovative battery expected to be higher in weight energy density than the rechargeable lithium-ion battery which is a focus of efforts in the research and development of a storage battery.

One of factors restricting the weight energy density of the rechargeable lithium-ion battery is a positive electrode material made of lithium-containing transition metal oxide typified by lithium cobaltate. Since a transition metal element which is a constituent element of the positive electrode material is heavy metal, assembling the positive electrode material into a storage battery results in an increase in weight. Consequently, the weight energy density decreases.

Hence, a metal-air battery in which oxygen in the atmosphere is used for the positive electrode material and metal is used for the negative electrode material is attracting attention.

In addition, since cost reductions due to a reduction in weight can be expected if such a metal-air battery is used for electrical power storage, expectations are increasingly high for the metal-air battery.

Like the lithium-ion battery, this metal-air battery requires substantial increases in the number of stacked layers, in electrode area, and in battery capacity, in order to secure practical output.

The metal-air battery is limited to practical use as a non-rechargeable metal-air battery, as typified by a zinc-based metal-air battery which until now has been used as a power supply for hearing aids. Accordingly, the metal-air battery has not yet been put into practical use as a rechargeable metal-air battery capable of charge and discharge.

The major reasons that the metal-air battery is prevented from being turned into a rechargeable battery include that the amount of overvoltage at the time of charge is large, that cycling characteristics are poor, and that catalyst life is short.

However, these reasons are primarily based on the viewpoint of materials.

Turning the non-rechargeable battery into a rechargeable battery involves the phenomenon that a negative-polarity electrode contracts and expands along with charge and discharge. This is a phenomenon in which the negative-polarity electrode contracts due to metal elution at the time of discharge and expands due to metal precipitation at the time of charge.

If substantial increases in the number of stacked layers, in electrode area, and in battery capacity are produced in particular for a volumetric change in such a negative-polarity electrode as described above, contact states of constituent members constituting the rechargeable metal-air battery are thought to deteriorate, thus degrading battery performance and service life.

No attempts have been made heretofore, however, to solve these problems from a structural point of view.

For example, as a stacked rechargeable metal-air battery, there is such a battery related to cooling among stacked cells as shown in JP Patent Publication (Kokai) No. 10-162870A (1998).

In addition, the rechargeable metal-air battery described in JP Patent Publication (Kokai) No. 2008-300346A is such that control is performed on the level of electrolytic solution at the time of volumetric change in a negative-polarity electrode, in order to maintain battery performance.

However, no measures are considered against volumetric change in the negative-polarity electrode in the rechargeable metal-air battery of the conventional technology. No considerations are given either to the problem of contact states.

Hence, an object of the present invention is to solve these problems by suppressing the increase of contact resistance due to dimensional change at the time of charge and discharge in a rechargeable metal-air battery, thereby improving battery performance and service life.

### SUMMARY OF THE INVENTION

A rechargeable metal-air battery according to one of the embodiments of the present invention includes: a negative electrode for storing and releasing metal ions; a positive electrode using oxygen as an active material; and an electrolyte membrane placed between the negative electrode and the positive electrode. The rechargeable metal-air battery is characterized in that a flexible dimension-absorbing member is disposed on the negative electrode side.

The dimension-absorbing member is preferably an elastic body. That is, the dimension-absorbing member needs to be formed of a substance which changes reversibly.

The dimension-absorbing member also preferably has an amount of elastic deformation of ( 1/100)D or larger when the thickness of the negative electrode is defined as D.

The dimension-absorbing member also preferably has an amount of elastic deformation equal to or larger than the amount of thickness change in the negative electrode calculated from capacity (Ah).

This is based on the relationship that if capacity (Ah) is determined, then the amount of thickness change in the negative electrode is determined. That is, outputting predetermined capacity (Ah) means releasing predetermined metal (Li, for example) from the negative electrode. Thus, the amount of thickness change is determined electrochemically. When predetermined metal (Li, for example) is released from the negative electrode, the thickness of the negative electrode changes and becomes thinner. For example, calculations are made as described below, using a negative electrode metal foil of pure Li, to determine how much the Li foil becomes thinner per 1 Ah discharge in a Li-air battery having an electrode area of 10 cm².

First, a discharge reaction in which Li is released is expressed as

Li→Li⁺+e⁻ (1)

Assuming that a capacity of 1 (Ah) is discharged at this time, then from the above-described formula, the number of moles of released Li can be described as below.

Number of moles (mol) of released Li=1×3600 (s)/F (C/mol) (2)

where F=96485 (C/mol): Faraday constant.

Therefore, a capacity of 1 Ah corresponds to 0.037 mol of Li which has been released and reacted. From an atomic mass of Li of 6.941 g/mol and a true density ρ of Li of 0.535 g/cm³, in addition to this number of moles, the released volume of Li for a capacity of 1 Ah is determined by the following equation:

Released volume of Li per 1 Ah=0.037 (mol)×6.941 (g/mol)/ρ (g/cm³)=0.484 cm³ (3)

Since the electrode area is 10 cm², the Li foil becomes thinner by 0.484/10=0.0484 cm for a discharge of 1 Ah. Conversely, the Li foil becomes thicker by 0.0484 cm for a charge of 1 Ah.

Therefore, the amount of thickness change in the negative electrode is determined from the area of the negative electrode and the capacity (Ah) (amount of change in metal (Li, for example)). From this point of view, it is possible to determine the amount of elastic deformation in the dimension-absorbing member.

Note that the abovementioned calculation example is given for a case in which the pure Li foil has a true density of 0.535 g/cm³. If, for example, the pure Li foil is made by sintering Li powder, and therefore, does not have the true density ρ, calculations may be made by substituting an apparent density ρ′ for ρ in equation (3). Furthermore, even if the negative electrode is not pure Li but contains a binding agent, is compounded with an electroconductive material such as carbon, or uses an Li alloy, the correct amount of elastic deformation in the dimension-absorbing member can be determined by previously measuring charging/discharging capacity and the then thickness of the negative-polarity electrode.

In addition, the dimension-absorbing member is preferably a porous body.

Furthermore, the dimension-absorbing member is preferably made of a high-thermal conductivity substance (Cu, Al or Ni).

In addition, the dimension-absorbing member preferably includes a gas flow path capable of supplying or exhausting a reaction gas.

Note that in the rechargeable metal-air battery described herein, pressure is preferably applied from the negative and positive electrode sides by pressure-applying means.

In addition, the rechargeable metal-air battery described herein is preferably provided with battery-cooling means and battery temperature-measuring means, so that battery temperature is controlled by the battery temperature-measuring means and the battery-cooling means.

Furthermore, in the rechargeable metal-air battery described herein, a gas-supplying member is preferably disposed on the positive electrode side.

That is, one embodiment of the present invention is best characterized by a stacked cell structure of a rechargeable metal-air battery in which a flexible dimension-absorbing member is disposed on the negative electrode side of an air battery and a gas-supplying member is disposed in a cell reaction layer on the positive electrode side.

Note that one embodiment of the present invention uses a dimension-absorbing member capable of providing an amount of elastic deformation of ( 1/100)D or larger when the thickness of the negative electrode is defined as D.

In addition, a sealing-treated gas flow path is provided in the dimension-absorbing member. Thus, the rechargeable metal-air battery is configured to be capable of supplying or exhausting a reaction gas through this gas flow path.

According to the present invention, it is possible to suppress the increase of contact resistance due to dimensional change at the time of charge and discharge in a rechargeable metal-air battery, thereby improving battery performance and service life.

### BRIEF DESCRIPTION OF THE DRAWINGS

FIG. 1 is a schematic view illustrating a cross-sectional structure of a rechargeable metal-air battery of the present embodiment.

FIG. 2 is a schematic view illustrating an embodiment in which a dimension-absorbing member and a gas-supplying member are integrated with each other.

FIG. 3 is a schematic view illustrating an embodiment in which a pressure-applying unit is simplified.

FIG. 4 is a schematic view illustrating an embodiment of a system for performing temperature control.

FIG. 5 is a schematic view illustrating an embodiment in which the thickness of dimension-absorbing members is varied in the stacking direction thereof.

### DETAILED DESCRIPTION OF THE PREFERRED EMBODIMENTS

In the present embodiment, a dimension-absorbing member is provided on the negative electrode side in a rechargeable metal-air battery. Consequently, it is possible to absorb dimensional changes in a negative-polarity electrode at the time of charge and discharge and favorably maintain the contact state of the negative-polarity electrode. Thus, it is possible to improve battery performance and service life, while allowing the battery to have a high weight energy density.

Hereinafter, embodiments of the present invention will be described with reference to the accompanying drawings.

### Embodiment 1

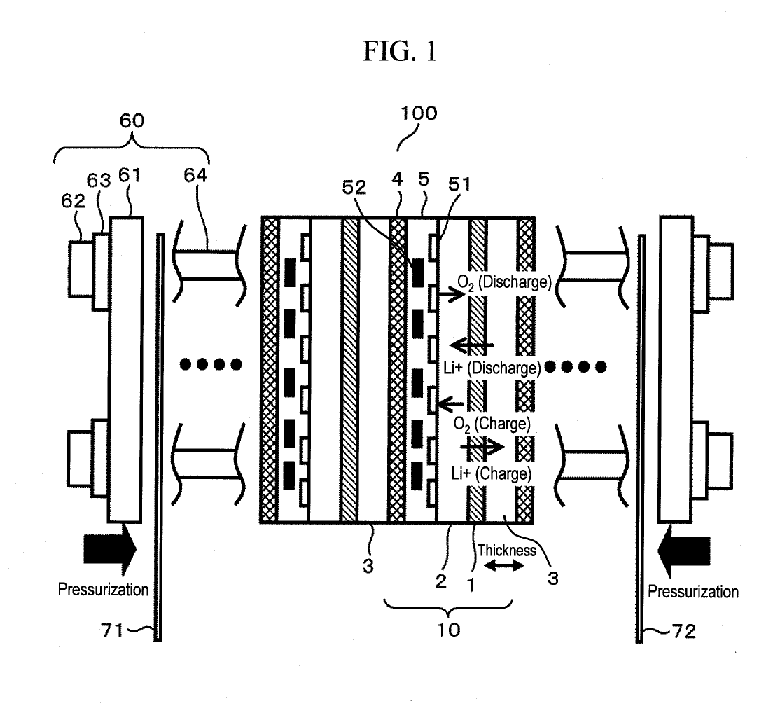

FIG. 1 illustrates a cross-sectional structure of the rechargeable metal-air battery of the present embodiment.

As a matter of convenience, the rechargeable metal-air battery of the present embodiment uses lithium as negative-electrode metal to be used for a negative electrode and a nonaqueous solvent as an electrolytic solution.

Note that zinc, aluminum, magnesium, or the like may be used as the negative-electrode metal, in addition to lithium. In addition, an aqueous solvent may be used as the electrolytic solution.

Furthermore, although in the present embodiment, metal is used for the negative electrode, the negative electrode may not be made of metal. Any material which undergoes dimensional change upon charging and discharging, as will be described later, results in advantageous effects of the present invention available. Therefore, a carbon material or an oxide material may be used, as long as the material can store and release metal ions. In the case of an air battery, however, whose energy density can be made higher by containing a large amount of active material metal in the negative electrode, a negative electrode using pure metal or an alloy is preferable. In such a negative electrode, the amount of dimensional change becomes larger particularly at the time of storing and releasing metal ions. Thus, with such a negative electrode, the advantageous effect of the present invention is more effectively provided, thereby providing an air battery high in energy density and capable of favorably maintaining the contact state of the battery.

In FIG. 1, a unit cell 10 includes an electrolyte membrane 1, a positive electrode 2, a negative electrode 3, a dimension-absorbing member 4, and a gas-supplying member 5. This unit cell 10 is stacked to configure a rechargeable metal-air battery 100 of the present embodiment.

For the electrolyte membrane 1, a microporous membrane, such as polyethylene, is used. This membrane is impregnated with an electrolytic solution prepared using a nonaqueous solvent, such as propylene carbonate, containing 1 molarity of LiPF₆ or the like as an electrolyte, so that the electrolyte membrane 1 undertakes Li ion conduction.

In general, a catalyst, such as manganese dioxide, is carried in the positive electrode 2 with carbon as a carrier, so that the positive electrode 2 undertakes charge/discharge reactions. However, since the present invention is related to dimensional change in the negative electrode, the catalyst is not limited to this.

The charge/discharge reactions of the rechargeable metal-air battery will be described according to this FIG. 1.

The discharge reaction is shown below:

(Negative electrode side) 2Li→2Li⁺+2e⁻ (4)

(Positive electrode side) O₂+2Li⁺+2e⁻→Li₂O₂ (5)

(Overall reaction) 2Li+O₂→Li₂O₂ (6)

In addition, the charge reaction is shown below:

(Negative electrode side) 2Li←2Li⁺+2e⁻ (7)

(Positive electrode side) O₂+2Li⁺+2e⁻←Li₂O₂ (8)

(Overall reaction) 2Li+O₂←Li₂O₂ (9)

In such charge/discharge reactions as shown above, the electrolyte membrane 1, the positive electrode 2, and the negative electrode 3 which are constituent members of the unit cell 10 need to be in a favorable contact state. This is because there is the possibility of degradation in battery performance and increase in contact resistance if any gap arises among the constituent members.

In these reaction formulas, there arises a reaction in which Li which is the metal of the negative electrode 3 liquates out into an electrolytic solution at the time of discharge, as shown in formula (4). Consequently, the electrode contracts in the thickness direction of the negative electrode 3 illustrated in FIG. 1.

Meanwhile, in these reaction formulas, Li ions in the electrolytic solution separates out on the negative electrode 3 at the time of charge, as shown in formula (7). Consequently, the negative electrode 3 expands in the thickness direction thereof illustrated in FIG. 1.

The amount of this contraction or expansion depends on how much Li which is the metal of the negative electrode 3 is used in charge/discharge reactions to cause the transformation Li [symbol] Li₂O₂. Here, assume that the thickness of the metal Li of the negative electrode 3 consumed in a discharge reaction is D1, with respect to the original thickness D0 of the metal Li. At this time, η shown in

η=D1/D0×100(%) (10)

is referred to herein as a coefficient of negative electrode utilization.

If η is 100% in the ultimate sense, it is possible to attain a theoretical weight energy density. In practice, however, the electrode itself breaks down so as to lose its original shape. Hence, the utilization coefficient is lower than 100%, thus leaving an unreacted amount of the metal Li.

This means that the weight of the unreacted amount of the metal Li exists as a surplus weight, thus lowering the utilization coefficient and decreasing the weight energy density. This is undesirable for the rechargeable metal-air battery.

It is therefore desirable to develop a rechargeable metal-air battery improved, as much as possible, in the utilization coefficient. However, if such charge/discharge reactions as described above are repeated, a gap due to a dimensional change in the electrode becomes liable to arise in a boundary face between the negative electrode 3 and the electrolyte membrane 1. Thus, there is the possibility of increase in contact resistance.

In addition, charge/discharge reactions progress partially only in contacted portions of the unit cell 10 unless uniform contact is maintained across in-plane areas of the unit cell 10. This may also cause degradation in battery performance.

However, none of conventional technologies available so far have offered a solution to the problem of dimensional change in the negative electrode at the time of charge/discharge.

Hence, the present embodiment is intended to solve this problem by configuring a rechargeable metal-air battery in which such a dimension-absorbing member 4 as illustrated in FIG. 1 is placed in close contact with the negative electrode 3.

Note that the negative electrode 3 described here is formed only of the metal Li. However, the rechargeable metal-air battery theoretically remains the same even in a case in which a mixture layer formed by mixing a binding agent, an electroconductive material, and the like is used for the negative electrode 3, along with the metal Li. Thus, the rechargeable metal-air battery is preferably configured by placing the dimension-absorbing member 4 in close contact with the negative electrode 3.

First, a utilization coefficient of 1% or higher is desirable from the viewpoint of a practical utilization coefficient. Accordingly, 1/100 of the initial thickness D of the negative electrode 3 participates in reactions. Hence, a material having an amount of elastic deformation equal to or larger than this amount of thickness change, i.e., satisfying a thickness change of ( 1/100)D or larger, preferably twice or more the thickness change (i.e., ( 2/100)D or larger), is placed in close contact with the negative electrode as the dimension-absorbing member 4 to configure the rechargeable metal-air battery.

By configuring the battery as described above, the battery is allowed to have an elastic deformation capacity larger than the amount of thickness change thereof even if the negative electrode 3 changes in thickness at a utilization coefficient of 1% at the time of charge/discharge. Consequently, the battery is always maintained in a favorable contact state.

In addition, considering a utilization coefficient of 100% in the ultimate sense, a maximum amount of elastic deformation of D suffices for the negative electrode. Furthermore, since the amount of thickness change in the metal Li is known from the capacity (Ah) of the unit cell 10, a dimension-absorbing member having an amount of thickness change larger than this amount of change may be disposed without committing to the utilization coefficient.

The material of the dimension-absorbing member needs to have electronic conductivity since the member requires electrical connection. More preferably, a material having high thermal conductivity, such as Cu, Al or Ni, may be used. Use of these materials makes the in-plane temperature distribution of the unit cell 10 uniform at the time of charge/discharge. Consequently, the unit cell 10 is less likely to have high-temperature portions and can be expected to have an improved service life.

Taking into consideration these requirements, a metal porous body, such as Cu, Al or Ni, having elastic deformation capacity and high thermal conductivity is preferred as the dimension-absorbing member 4.

For this metal porous body, such a material as foam metal or a felty material made by knitting fibers may be used.

In addition, some materials have a porosity as high as 90 to 98%. Use of such a material can prevent an increase in weight, and therefore, is preferred. Among these materials, Cu is low in reactivity with Li and is most suitable as a current-collecting material.

Furthermore, in the present embodiment, a gas-supplying member 5 is provided between the positive electrode 2 and the dimension-absorbing member 4. This is because an oxygen-containing gas needs to be supplied to the positive electrode 2 for reasons of the principles of an air battery.

In cases where the dimension-absorbing member 4 is poor in gas circulation, or so large in pressure loss as to increase motive energy for gas supply, this gas-supplying member 5 is required.

A reaction gas flow path 51 is formed in the gas-supplying member 5 by using a dense material. By allowing the oxygen-containing gas to pass through this flow path, oxygen is supplied to the positive electrode 2 to cause a discharge reaction. In addition, oxygen is exhausted from the reaction gas flow path 51 at the time of charge reaction.

In addition, a coolant flow path 52 is formed in the gas-supplying member 5. A cooling medium (cooling air, water, or the like) for removing heat generated in charge/discharge reactions can be made to pass through this flow path. As a matter of course, not only a cooling medium but also a medium for warm-up operation, such as warm water, can be flowed through the coolant flow path 52 for the purpose of start-up in cold districts.

Noted that this gas-supplying member 5 is desirably a high-thermal conductivity body for the same reasons as with the dimension-absorbing member 4.

The unit cell 10 configured in this way by disposing the dimension-absorbing member 4 and the gas-supplying member 5 is stacked.

In addition, current terminals 71 and 72 are respectively attached to two ends of the stacked cells. There is formed a rechargeable metal-air battery 100 in which pressure is applied from both sides by a pressure-applying unit 60 including an insulating end plate 61, a tightening nut 62, a tightening spring 63, and a tightening rod 64.

As this pressure, there is applied a pressure of, for example, 0.01 MPa to several MPa which is equal to or lower than such a pressure as not to cause damage to the electrolyte membrane 1, the positive electrode 2 and the negative electrode 3.

Here, the rechargeable metal-air battery of the present embodiment is completed by disposing a dimension-absorbing member 4 whose amount of elastic deformation is at least ( 1/100)D at a pressure of approximately 0.01 MPa to several MPa when the initial thickness of the negative electrode 3 is defined as D.

Since the dimension-absorbing member 4 is disposed and pressure is applied in the rechargeable metal-air battery configured in this way, a thickness change in the negative electrode 3 at the time of charge/discharge is absorbed by means of elastic deformation in the dimension-absorbing member 4. Consequently, a favorable contact state can be always maintained within each unit cell 10 and between the unit cells 10.

The above-described configuration is especially effective when the metal Li of the negative electrode 3 is used at a high utilization coefficient, thus leading to an improvement in weight energy density.

In addition, since the gas-supplying member 5 is also disposed to facilitate gas supply and exhaust, charge/discharge reactions of an air battery can be caused also easily.

Furthermore, since both of the dimension-absorbing member 4 and the gas-supplying member 5 are formed of a high-thermal conductivity body, such as Cu, Al or Ni, the in-plane temperature distribution of the unit cells 10 is easily uniformized.

Effects of vibrational absorption can be attained additionally by disposing the dimension-absorbing member 4. Accordingly, the rechargeable metal-air battery is also suitable as an electrical storage system for electric vehicles.

Note that although stacked cells have been described in FIG. 1, the gist of the present embodiment is that the rechargeable metal-air battery is configured so as to absorb dimensional changes in the negative electrode 3. Accordingly, the same advantageous effects can be obtained, as a matter of course, even in a single-cell battery composed of one cell.

In the rechargeable metal-air battery configured as described above, the contact state of the battery can be maintained favorably even if the utilization coefficient of the metal Li used for the negative electrode 3 is made higher. Consequently, it is possible to provide a rechargeable metal-air battery having a high weight energy density and improved in battery performance and service life in terms of charging/discharging operation.

According to the present embodiment, the increase of contact resistance due to dimensional changes at the time of charge/discharge can be suppressed in the rechargeable metal-air battery, even if the utilization coefficient of metal used for the negative electrode 3 is made higher. Thus, an effect of improving battery performance and service life can be attained, while concurrently improving weight energy density.

In addition, the temperature distribution of a cell can be made uniform when the cell is substantially increased in area. Accordingly, it is possible to attain an effect of being able to improve battery performance and service life.

### Embodiment 2

The dimension-absorbing member 4 and the gas-supplying member 5 may at least be able to functionally satisfy two requirements, i.e., the members can (1) absorb dimensional changes and (2) supply gases, respectively.

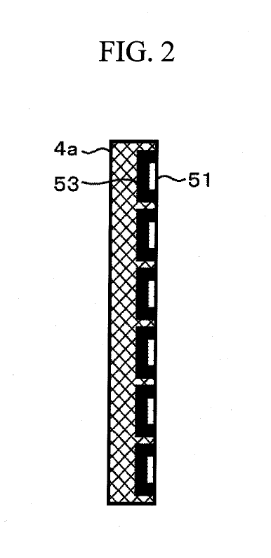

FIG. 2 is a schematic view illustrating an embodiment in which a dimension-absorbing member and a gas-supplying member are integrated with each other.

As illustrated in FIG. 2, a reaction gas flow path 51 is provided in a porous body 4a having elastic deformation capacity. The advantageous effects of the present embodiment are also attained by performing a sealing treatment with a reaction gas sealer 53, so that a reaction gas flowing through this flow path flows into the positive electrode 2 alone.

This sealing treatment can be performed in a simplified manner by impregnating the porous body with a sealing agent. Thus, it is possible to reduce the number of components and decrease a height in the stacking direction of the battery.

This sealing treatment leads to cost reductions and reductions in battery size, as well as to reductions in weight, and is therefore preferable.

### Embodiment 3

The pressure-applying unit 60 is not limited to the one illustrated in FIG. 1. Alternatively, the pressure-applying unit 60 may be configured so that stacked cells are in a state of being pressurized while in use.

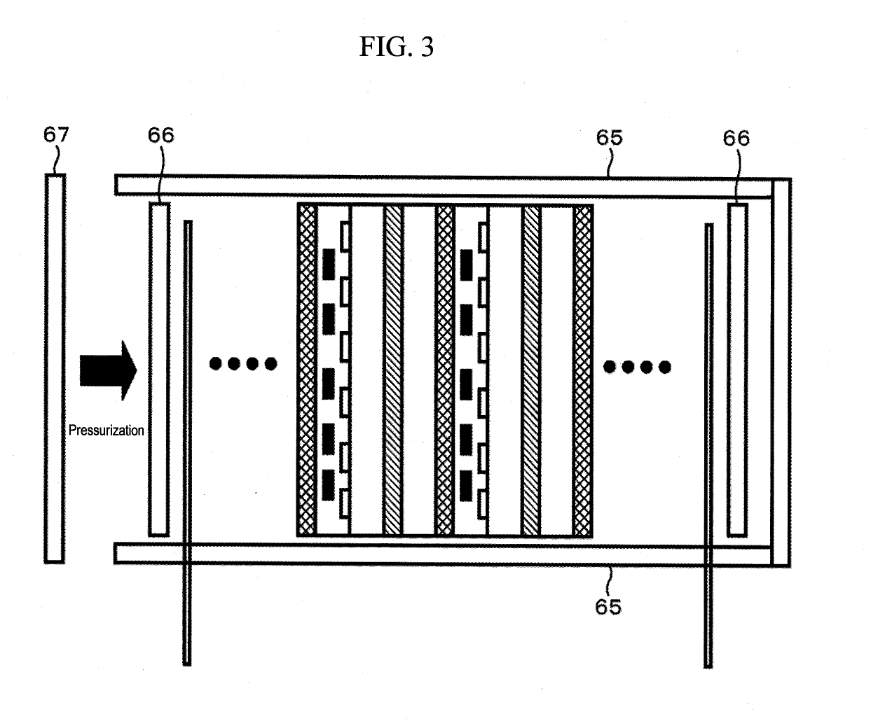

FIG. 3 is a schematic view illustrating an embodiment in which the pressure-applying unit is simplified.

FIG. 3 illustrates a configuration in which a tightening battery container 65 and an insulating cushion 66 are disposed.

This is an example in which a pressure is applied by disposing the insulating cushion 66, and then a rechargeable metal-air battery as a whole is fixed in a canned manner with the battery container 65 and a closing cover 67.

As the insulating cushion 66, rubber, for example, may be used.

As the battery container 65, metal or a laminate film may be used.

As a method of assembly, unit cells 10 are stacked in the battery container 65, current terminals 71 and 72 and an insulating cushion 66 are stacked, a pressure is applied, and finally the battery container 65 is sealed with the closing cover 67.

This sealing is performed by means welding, caulking, or the like.

Configuring the rechargeable metal-air battery in this way leads to the simplification of the pressure-applying unit 60, thereby further reducing the weight and volume of the battery.

Note that the gist of the present embodiment is that there is adopted means for maintaining a state in which a pressure at the time of assembly is also kept applied during use. Accordingly, the battery configuration is not limited to those illustrated in FIGS. 1 and 3, but various other configurations may be adopted.

### Embodiment 4

The present embodiment is intended to facilitate the temperature control of a unit cell 10.

It is commonly known that too high a temperature of a battery causes a degradation in performance or a decrease in service life. To this effect, temperature control is performed in the present embodiment.

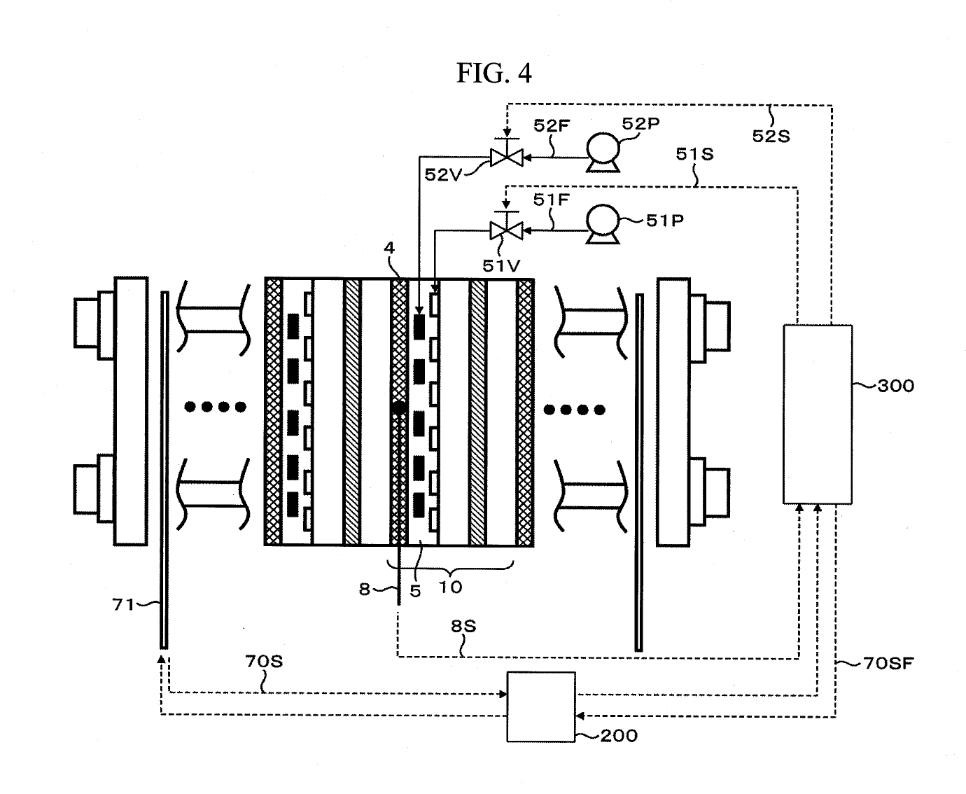

FIG. 4 is a schematic view illustrating an embodiment of a system for performing temperature control.

As illustrated in FIG. 4, a thermocouple 8 is inserted into a dimension-absorbing member 4. The thermocouple 8 is electrically isolated from a unit cell 10. Here, the thermocouple 8 is used to measure the temperature of the unit cell 10.

The thermocouple 8 is preferably provided without inserting into the reaction gas flow path of a gas-supplying member 5. Consequently, the temperature of the unit cell 10 can be measured without disturbing the supply of a reaction gas.

In addition, use of a thermocouple having a small diameter of, for example, approximately 0.5 mm for the thermocouple 8 enables temperature measurement without impairing the flexibility of the dimension-absorbing member 4.

Next, a specific way of temperature control will be described.

First, a temperature-sensing signal 8S measured by the thermocouple 8 is input to an overall control apparatus 300.

If the temperature of the unit cell 10 exceeds a certain threshold (60° C., for example), the opening of a coolant flow rate control valve 52V is adjusted by a signal 52S from the overall control apparatus 300, so as to increase the coolant flow rate 52F of a coolant pump 52P. As a result, the temperature detected by the thermocouple 8 lowers. Consequently, the temperature of the unit cell 10 can be adjusted to keep it within a correct range.

An embodiment has been shown above in which the temperature control of the unit cell 10 is performed by adjusting the flow rate of a cooling medium in this way. Alternatively, as illustrated in FIG. 4, the temperature of the unit cell 10 can be decreased by inputting a current-value signal 70S (detected from the current terminal 71) of the rechargeable metal-air battery to a load control unit 200 and lowering this current value by a control signal 70 SF from the overall control apparatus 300.

In addition, the reaction gas flow rate 51F of the reaction gas pump 51P is adjusted by adjusting the opening of the reaction gas flow rate control valve 51V by using a reaction gas flow rate control signal 51S from the overall control apparatus 300.

However, too high a value of the reaction gas flow rate 51F may lead to the evaporation of an electrolytic solution. In addition, it may not be possible to decrease the current value for reasons of system requirements. Accordingly, for effective cooling of the unit cell 10, it is most desirable to perform temperature control by adjusting the flow rate of a cooling medium.

### Embodiment 5

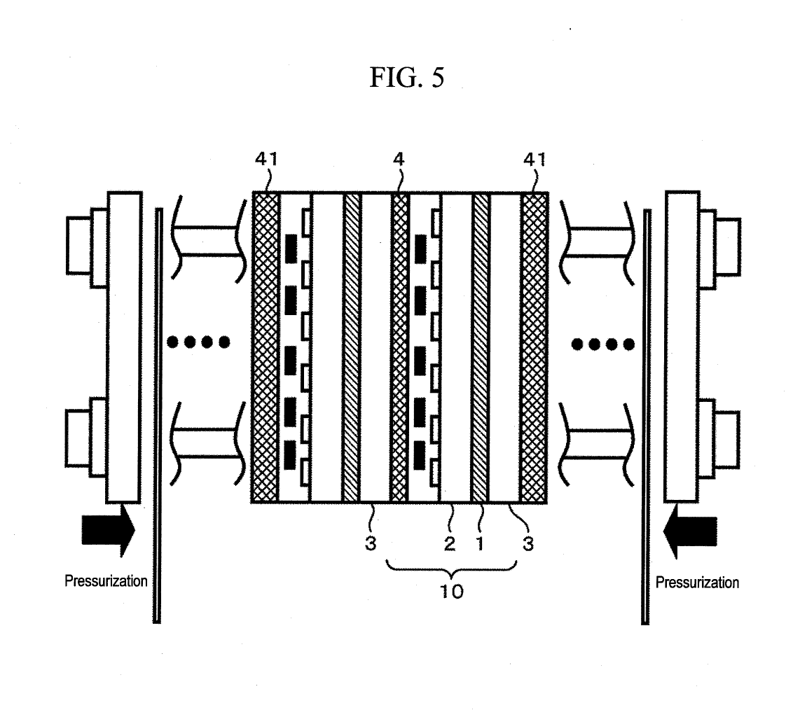

FIG. 5 is a schematic view illustrating an embodiment in which the thickness of dimension-absorbing members is varied in the stacking direction thereof.

As illustrated in FIG. 5, a dimension-absorbing member larger in the amount of elastic deformation than a dimension-absorbing member 4 in the central part of a battery is used for a dimension-absorbing member 41 on a side closer to a pressure-applying unit 60 (edge side), when stacking unit cells 10.

As an example of simplified configuration, the same material is used for the dimension-absorbing members and, as illustrated in FIG. 5, the thickness of the dimension-absorbing member 41 is made larger than that of the dimension-absorbing member 4. Consequently, it is possible for the dimension-absorbing member 41 to have a larger amount of elastic deformation.

In general, the amounts of dimensional change in the respective unit cells are summed up at the time of stacking, to amount to a large value on the edge side. Consequently, contact failure is more likely to occur on the side. For this reason, the amount of dimensional absorption on the edge side is made larger, thereby ensuring favorable contact states of the respective unit cells even in highly multilayer stacked cells.

In the present embodiment, only the thickness is varied between the dimension-absorbing member 41 and the dimension-absorbing member 4. Alternatively, if the dimension-absorbing members are porous bodies, the porosity thereof, for example, may be varied to replace the dimension-absorbing member 41 with one having a larger amount of elastic deformation.

The present invention relates to a rechargeable metal-air battery capable of charge and discharge, and is applicable to a storage battery serving as a source of electrical energy supply to electric vehicles and the like.

### DESCRIPTION OF SYMBOLS

1 Electrolyte membrane
2 Positive electrode
3 Negative electrode
4 Dimension-absorbing member
4a Dimension-absorbing member
5 Gas-supplying member
8 Thermocouple
8S Temperature-sensing signal
10 Unit cell
51 Reaction gas flow path
51F Reaction gas flow rate
51P Reaction gas pump
51S Reaction gas flow rate control signal
51V Reaction gas flow rate control valve
52 Coolant flow path
52F Coolant flow rate
52P Coolant pump
52S Coolant flow rate control signal
52V Coolant flow rate control valve
53 Reaction gas sealer
60 Pressure-applying unit
61 Insulating end plate
62 Tightening nut
63 Tightening spring
64 Tightening rod
65 Battery container
66 Insulating cushion
67 Closing cover
71, 72 Current terminal
200 Load control unit
300 Overall control apparatus

What is claimed is:

1. A rechargeable metal-air battery comprising:
a negative electrode for storing and releasing metal ions;
a positive electrode using oxygen as an active material; and
an electrolyte membrane placed between the negative electrode and the positive electrode,
wherein a flexible dimension-absorbing member is disposed on the side of the negative electrode.

2. The rechargeable metal-air battery according to claim 1, wherein the dimension-absorbing member is an elastic body.

3. The rechargeable metal-air battery according to claim 1, wherein the dimension-absorbing member has an amount of elastic deformation of ( 1/100)D or larger when the thickness of the negative electrode is defined as D.

4. The rechargeable metal-air battery according to claim 1, wherein the dimension-absorbing member has an amount of elastic deformation equal to or larger than the amount of thickness change in the negative electrode calculated from capacity (Ah).

5. The rechargeable metal-air battery according to claim 1, wherein the dimension-absorbing member is a porous body.

6. The rechargeable metal-air battery according to claim 1, wherein the dimension-absorbing member is a high-thermal conductivity body.

7. The rechargeable metal-air battery according to claim 1, wherein the dimension-absorbing member includes a gas flow path capable of supplying or exhausting a reaction gas.

8. The rechargeable metal-air battery according to claim 1, wherein a pressure is applied from the side of the negative electrode and from the side of the positive electrode by pressure-applying means.

9. The rechargeable metal-air battery according to claim 1, wherein battery-cooling means and battery temperature-measuring means are provided and battery temperature is controlled by the battery temperature-measuring means and the battery-cooling means.

10. The rechargeable metal-air battery according to claim 1, wherein a gas-supplying member is disposed on the side of the positive electrode.
